(19) United States
(12) Patent Application Publication
(10) Pub. No.: US 2004/0079581 A1
(43) Pub. Date: Apr. 29, 2004

(54) Acoustic insulation barrier for railway lines

(75) Inventor: Osvaldo Fasano, Villarbasse (Torino) (IT)

Correspondence Address: SUGHRUE MION, PLLC, Suite 800, 2100 Pennsylvania Avenue, NW, Washington, DC, 20037-3213, US

(73) Assignee: F.LLI DEMATTEIS S.r.L

(21) Appl. No.: 10/408,223

(22) Filed: Apr. 8, 2003

(30) Foreign Application Priority Data
Apr. 8, 2002 (IT) TO2002A000303

(51) Int. Cl. B64F 1/26

(52) U.S. Cl. 181/210

(57) ABSTRACT

Acoustic insulation barrier for railway lines, characterised in that it comprises, for each rail (10), two continuous arrays (18, 20) of sound-absorbing elements (22) positioned at opposite parts of the rail (10) and connected to the flange (12) of the rail (10).

The present invention relates to an acoustic insulation barrier for railway lines. More specifically, the present invention relates to an acoustic insulation barrier destined to intercept the noises generated by the passage of a train in the immediate vicinity of their source.

The document EP-A-1081286 describes a support device which allows to connect devices of various types, such as pedestrian platforms and safety barriers, to the flange of a railway rail. This document also describes elements reflecting acoustic waves, connected to the flange of the railway rail in such a way as to form a noise-suppressing barrier positioned in the immediate vicinity of the railway line.

The aim of the present invention is to provide an enhanced acoustic insulation barrier which allows to improve the ability to absorb the noise generated by a railway vehicle travelling on rails.

According to the present invention, said aim is achieved by an acoustic insulation barrier having the characteristics set out in the claims.

The present invention shall now be described in detail with reference to the accompanying drawings, provided purely by way of non limiting example, in which:

FIG. 1 is a plan view of a segment of a railway line provided with an acoustic insulation barrier according to the present invention,

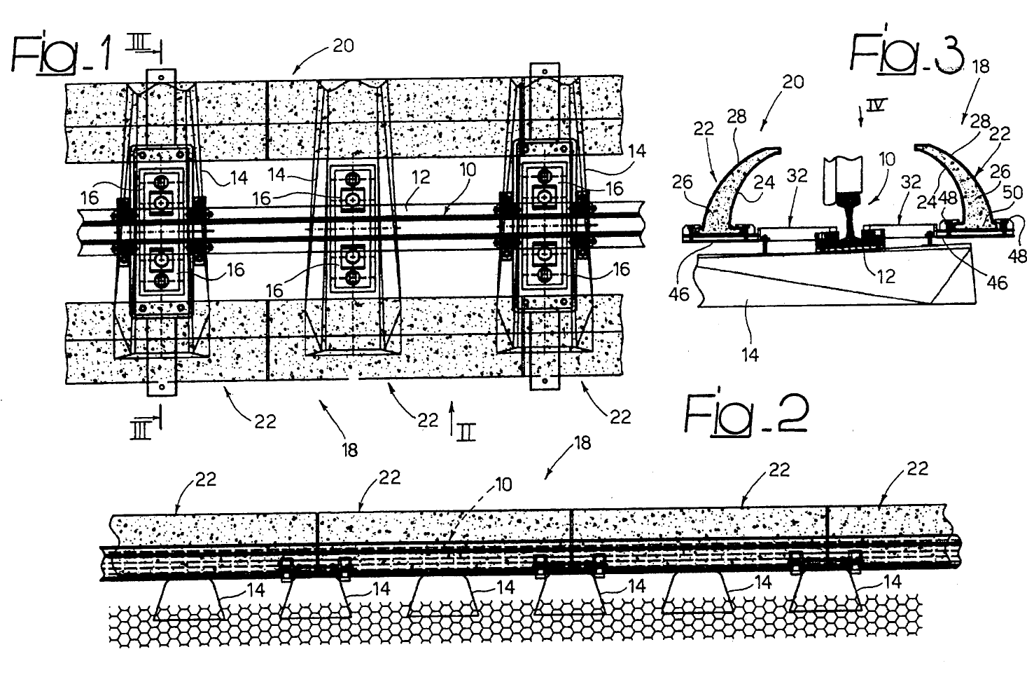

FIG. 2 is a lateral view according to the arrow II of FIG. 1,

FIG. 3 is a section according to the line III-III of FIG. 1,

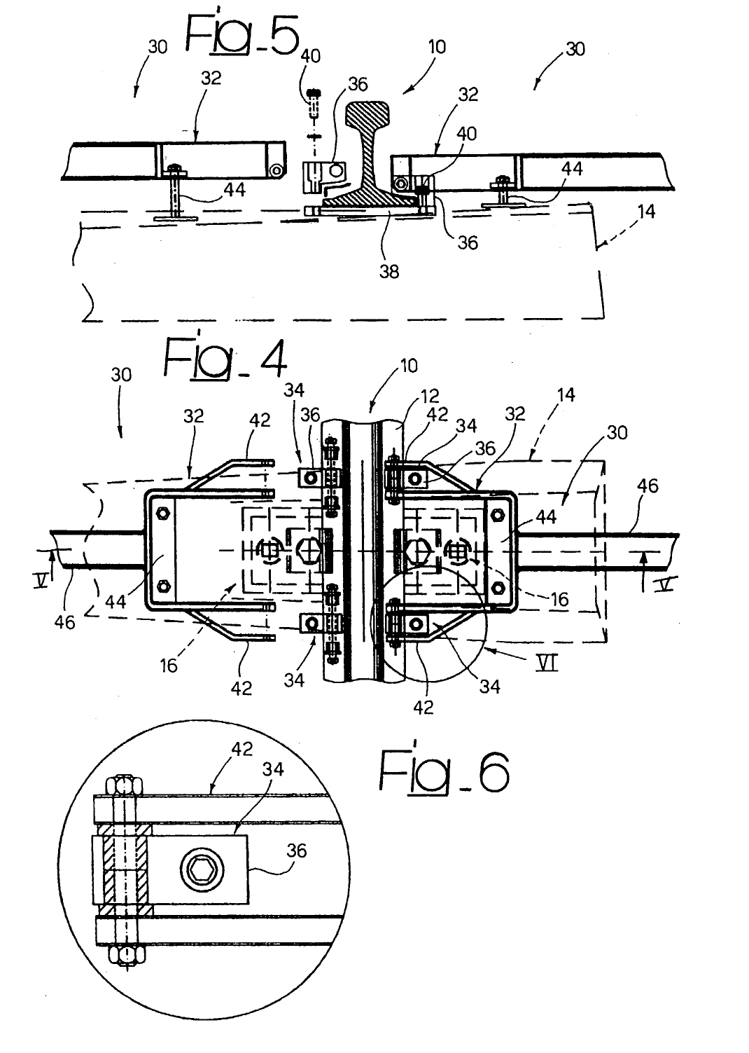

FIG. 4 is a plan view in enlarged scale of the part indicated by the arrow IV in FIG. 3,

FIG. 5 is a section according to the line V-V of FIG. 4,

FIG. 6 is a detail in enlarged scale of the part indicated by the arrow VI in FIG. 4,

FIG. 7 is a cross section showing a variation of the acoustic insulation barrier according to the present invention,

FIG. 8 is plan view of a second variation of the present invention,

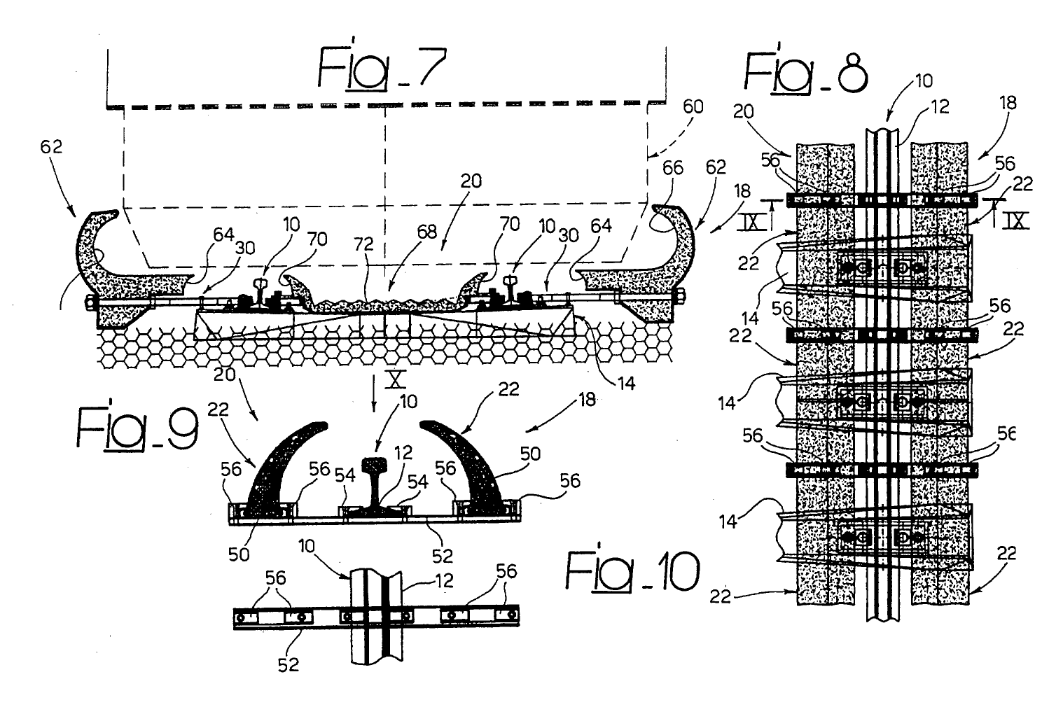

FIG. 9 is a section according to the line IX-IX of FIG. 8, and

FIG. 10 is a plan view according to the arrow X of FIG. 9.

With reference to FIGS. 1 through 3, the number 10 designates a rail of a railway line. The description that follows refers to a single rail but it is understood that what is stated herein applies in identical fashion to the complementary rail of the railway line. The rail 10 has a flange 12 which is fastened to sleepers 14 by means of conventional fastening members 16.

To each rail 10 of the railway line is associated an acoustic insulation barrier formed by two continuous arrays 18, 20 of sound-absorbing elements 22. The arrays 18, 10 extend parallel to the rail 10 at opposite parts thereof. Each rail 10 of the railway line is associated to an outer array 18 and to an inner array 20 of sound-absorbing elements. Each railway line is therefore provided with a total of four arrays of sound-absorbing elements.

In the embodiment shown in FIGS. 1 through 3, the sound-absorbing elements 22 of the outer array 20 are mutually identical. In each array, the sound-absorbing elements 22 abut at their heads in such a way as to form a continuous barrier parallel to the rail 10. Each sound-absorbing element 22 is substantially shaped as a tile which, in its cross section, is tapered from the base towards the free end. Each sound-absorbing element 22 has a concave inner surface 24 oriented towards the rail 10.

The sound-absorbing elements 22 can be constituted by materials of different nature. Preferably, each sound-absorbing element 22 has a core 26 constituted by material with high sound-absorbing capacity, preferably recycled material, for instance constituted by rubbery conglomerates, synthetic mixes and the like. The core 26, whose function is to absorb noise, is preferably surrounded either totally or partially by an exterior shell 28 made of metallic or plastic material, preferably aluminium. In the embodiment shown in FIG. 3, the shell 28 covers the entire outer surface of the core 26. Alternatively, the shell 28 could be present solely in correspondence with the outer convex back and in correspondence with the base of the sound-absorbing element 22, in such a way as to leave the concave surface 24 without a rigid coating. In this way, the sound waves that propagate outwards starting from the rail 10 impact directly against the surface 24 of material with high sound absorption capacity. This allows considerably to improve the sound absorbing capacity of the barrier. The upper edge of each sound-absorbing element 22 is tangential to a substantially horizontal plane in such a way as to form a sound containment area that is as closed as possible around the area where the noise is generated.

The arrays 18, 20 of sound-absorbing elements 22 are connected to the flange 12 of the railway rail. FIGS. 4, 5 and 6 show a first embodiment of the system for connecting the sound-absorbing elements 22 to the rail 10. The connection system comprises a plurality of attachment devices 30 each of which comprises a bracket 32 articulated to the flange 12 of the rail 10 about an axis parallel to the axis of the rail. Each bracket 32 is connected to the flange 12 of the rail 10 by means of a pair of attachments 34 positioned at opposite sides relative to the members 16 for fastening the rail 10 to a sleeper 14. Each attachment 34 comprises a block 36 fastened to a plate 28 which extends below the flange 12 of the rail 10. The blocks 36 are fastened to the plate 38 by means of screws 40. The bracket 32 has two fork shaped ends 42 each of which is articulated to a respective block 36. Each bracket 32 is also provided with a support element 44 adjustable in height with bears down on the upper surface of the respective sleeper 14.

With reference to FIG. 3, each bracket 32 has an extension arm 46 which bears at its outer end relative to the rail 10 a pair of attachments 48 which engage the base 50 of a sound-absorbing element 22 or of two elements abutting each other at the head. The attachments 48 are fastened to the arm 46 by means of screws.

FIGS. 8, 9 and 10 show a variation of the acoustic insulation barrier according to the present invention. The elements corresponding to those described previously are designated by the same numeric references. The sound-absorbing elements 22 shown in FIGS. 8 and 9 are identical to those described with reference to FIGS. 1 through 3. The variation of FIGS. 8-10 differs from the embodiment described above in that it uses a simpler and more economical system to connect the sound-absorbing elements 22 to the rail 10. In this variation, the connection system comprises a plurality of plates 52 which extend below the flange 12 of the rail 10. Each plate 52 is fastened to the flange 12 of the rail 10 by means of a pair of blocks 54 which act on the upper surface of the flange 12 and are fastened to the lower plate 52 by means of screws. Each end of the plate 52 bears a pair of blocks 56 which engage the base 50 of a sound-absorbing element 22 or of two sound-absorbing elements 22 abutting each other by the head. The blocks 56 are fastened to the plate 52 by means of respective screws.

The shape, the dimensions of the sound-absorbing elements 22 and their distance from the rail 10 are determined in such a way as to avoid any interference with railway vehicles.

FIG. 7 shows a possible variation of the present invention in which the shape, the dimensions and the distances of the sound-absorbing elements are determined according to the outer profile of a railway vehicle with low distance from the ground, schematically indicated as 60 in FIG. 7. In the variation of FIG. 7, the outer sound-absorbing elements 62 have a first concave surface 64 oriented towards the rail 10 and positioned below the outer profile of the railway vehicle 60. Each outer sound-absorbing element 62 also has a second concave surface 66 having substantially semi-circular shaped, situated laterally and externally relative to the outer profile 60. The acoustic insulation barrier shown in FIG. 7 comprises and internal sound-absorbing element 68 which extends between the two rails 10 of the railway line. The internal sound-absorbing element has two lateral portions with concave surfaces 70 oriented towards the rail 10 and a central portion 72 that bears down on the sleeper 14 in the space between the two rails 10. The concave surfaces 64, 70 oriented towards the rail 10 have slightly greater height than the rail 10 to avoid interference with the profile 60 of the railway vehicle.

1. Acoustic insulation barrier for railway lines, characterised in that it comprises, for each rail (10), two continuous arrays (18, 20) of sound-absorbing elements (22, 62, 68) positioned at opposite parts of the rail (10) and connected to the flange (12) of the rail (10).

2. Acoustic insulation barrier as claimed in claim 1, characterised in that said sound-absorbing elements (22) have respective concave surfaces (24, 62, 68) oriented towards the rail (10).

3. Acoustic insulation barrier as claimed in claim 1, characterised in that each of said sound-absorbing elements (22, 62, 68) comprises a core (26) made of material with high sound absorbing capacity and an outer coating (28) which covers at least a part of said core (26).

4. Acoustic insulation barrier as claimed in claim 3, characterised in that each of said sound-absorbing elements (22, 62, 68) has at least a surface (24, 64, 70) without coating oriented towards the rail (10).

5. Acoustic insulation barrier as claimed in claim 1, characterised in that said arrays of sound-absorbing elements (22) are connected to the flange (12) of the rail (10) by means of a plurality of brackets (32) articulated to the flange (12) about respective axes parallel to the rail (10).

6. Acoustic insulation barrier as claimed in claim 1, characterised in that said arrays (18, 20) of sound-absorbing elements (22) are connected to the flange (12) of the rail (10) by means of a plurality of plates (52) fastened to the flange (12) of the rail (10).

7. Acoustic insulation barrier as claimed in claim 6, characterised in that each of said plates (52) is fastened to the flange (12) by means of a pair of blocks (54) and is provided at its ends with attachments (56) for fastening the base portion (50) of the sound-absorbing elements (22).

8. Acoustic insulation barrier as claimed in claim 1, characterised in that the sound-absorbing elements (22) of the outer array (18) and of the inner array (20) are mutually identical.

9. Acoustic insulation barrier as claimed in claim 1, characterised in that the sound-absorbing elements (62) forming the outer array (18) are different from the sound-absorbing elements (68) forming the inner array (20).

10. Acoustic insulation barrier as claimed in claim 9, characterised in that each of the sound-absorbing elements (68) forming the inner array (20) comprises a central portion (72) that extends between two rails (10) and two lateral portions with concave surfaces (70) oriented towards the respective rails (10).
